(19) United States
(12) Patent Application Publication
(10) Pub. No.: US 2013/0330645 A1
(43) Pub. Date: Dec. 12, 2013

(54) VEHICULAR FUEL CELL SYSTEM

(71) Applicant: SUZUKI MOTOR CORPORATION, Hamamatsu-shi (JP)

(72) Inventors: Kazuyuki HIROTA, Hamamatsu-shi (JP); Shinichiro TAKADA, Hamamatsu-shi (JP); Naoki OZAWA, Hamamatsu-shi (JP)

(21) Appl. No.: 13/907,537

(22) Filed: May 31, 2013

(30) Foreign Application Priority Data
Jun. 6, 2012 (JP) 2012128983

(51) Int. Cl. H01M 8/04

(52) U.S. Cl. CPC H01M 8/04201
USPC 429/429; 429/513; 429/439

(57) ABSTRACT

There is provided a vehicular fuel cell system. A fuel gas supply path is configured to supply fuel gas from a fuel gas container to a fuel cell stack. A primary decompression valve is disposed on the fuel gas supply path. A secondary decompression valve is disposed on the fuel gas supply path at a downstream side of the primary decompression valve. The secondary decompression valve is fixed to the fuel cell stack.

### CROSS-REFERENCE TO RELATED APPLICATIONS

This application claims the benefit of Japanese Application No. 2012-128983, filed Jun. 6, 2012, in the Japanese Patent Office, the disclosure of which is incorporated herein by reference.

### BACKGROUND OF THE INVENTION

1. Field of the Invention

The invention relates to a vehicular fuel cell system, and more particularly, to a vehicular fuel cell system capable of preventing a pressure of fuel gas which is supplied to a fuel cell stack mounted on a vehicle from being reduced.

2. Description of the Related Art

A vehicular fuel cell system includes a water-cooling type and an air-cooling type. The fuel cell system of the air-cooling type has a simpler structure as compared with the fuel cell system of the water-cooling type, so that it is suitable for a small-sized vehicle. In a vehicular fuel cell system of the related art, a fuel gas supply piping part for supplying hydrogen which is the fuel gas from a fuel gas container to a fuel cell, a container that collects therein produced water of the fuel cell, a discharge piping part that guides the produced water of the fuel cell to the container and a discharge valve that discharges the produced water in the container are accommodated in the container so that the system is reduced in size (Patent Document 1). Also, in a vehicular fuel cell system of the related art, a shutoff valve for shutting off flowing of the fuel gas is arranged at a gas piping that is connected to a gas consuming device such as fuel cell, and when shutting down the gas consuming device, the shutoff valve is closed so as to enable the gas consuming device to consume the fuel gas in the gas piping until a pressure difference between upstream and downstream sides of the shutoff valve becomes a predetermined value and then the gas consuming device is shut down, so that the sealing performance of the shutoff valve is improved (Patent Document 2).

Patent Document 1: JP-A-2008-130329

Patent Document 2: JP-A-2006-156320

When mounting the fuel cell system on a small-sized vehicle, since a space for arranging a running motor, the fuel gas container, the fuel cell stack and the like is limited, it is difficult to closely mount both the fuel cell stack and the fuel cell container. If the fuel cell stack and the fuel cell container are arranged apart from each other, a fuel gas supply path connecting the fuel cell stack and the fuel cell container increases in length, so that pressure loss occurs. In the vehicular fuel cell system of the water-cooling type, the pressure of the fuel gas to be supplied to the fuel cell stack is at least 100 kPa (gage) or higher. Therefore, the influence of the pressure loss which occurs in the fuel gas supply path, on the pressure of the fuel gas to be supplied to the fuel cell stack is insignificant. However, in the vehicular fuel cell system of the air-cooling type, the pressure of the fuel gas to be supplied to the fuel cell stack is very low and is substantially equivalent to an atmospheric pressure. Therefore, if the pressure loss occurs as the fuel gas supply path connecting the fuel cell stack and the fuel cell container increases in length, it may not be possible to supply the fuel gas to the fuel cell stack with a required pressure.

### SUMMARY OF THE INVENTION

It is therefore an object of the present invention is to provide a vehicular fuel cell system capable of supplying fuel gas to a fuel cell stack with an appropriate pressure.

Accordingly, in order to achieve the above object, according to an aspect of the embodiments of the present invention, there is provided a vehicular fuel cell system comprising: a fuel gas container; a fuel cell stack; a fuel gas supply path configured to supply fuel gas from the fuel gas container to the fuel cell stack; a primary decompression valve disposed on the fuel gas supply path; and a secondary decompression valve disposed on the fuel gas supply path at a downstream side of the primary decompression valve, wherein the secondary decompression valve is fixed to the fuel cell stack.

With this configuration, since the secondary decompression valve is attached to the fuel cell stack, it is possible to reduce a passage length of the fuel gas supply path from the secondary decompression valve to the fuel cell stack. Thus, it is possible to prevent a pressure of the fuel gas to be supplied to the fuel cell stack from being reduced due to the pressure loss that occurs at a downstream side of the secondary decompression valve on the fuel gas supply path. Therefore, according to the aspect of the embodiments of the present invention, it is possible to supply the fuel gas to the fuel cell stack with an appropriate pressure during the operation of the fuel cell stack. Also, since it is possible to attach and detach the secondary decompression valve to and from the vehicle in a state where the secondary decompression valve is mounted on the fuel cell stack in advance, the mounting capability of the secondary decompression valve and the fuel gas supply path is improved and the maintenance capability is also improved.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view illustrating a fuel gas supply system of a vehicular fuel cell system according to an embodiment of the present invention.

FIG. 2 is a schematic view illustrating a layout of the vehicular fuel cell system which is mounted on a vehicle.

FIG. 3 is a block diagram of the vehicular fuel cell system of an air-cooling type.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

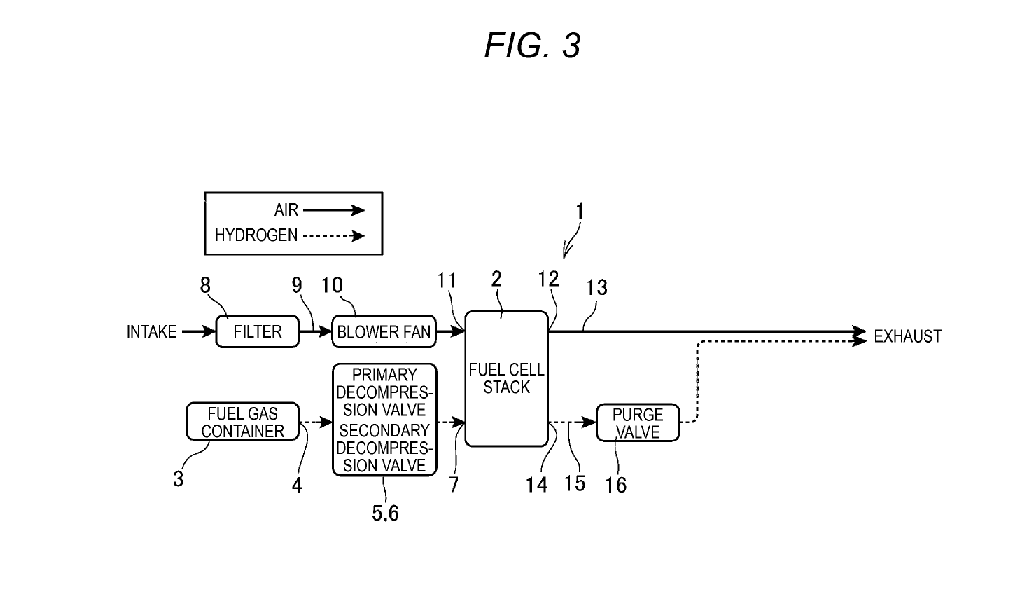

FIG. 3 is a block diagram of a vehicular fuel cell system 1. The vehicular fuel cell system 1 is of an air-cooling type in which the air is used as a reaction gas and a refrigerant. In the fuel cell system of the air-cooling type, pressures of fuel gas (hydrogen gas) and air (oxidation gas) to be supplied to a fuel cell stack are low, as compared with a fuel cell system of a water-cooling type. The vehicular fuel cell system 1 is provided with a fuel cell stack 2 in which a plurality of cells each of which is the minimum constitutional unit, are stacked. In the vehicular fuel cell system 1, high-pressure fuel gas (compressed hydrogen gas) stored in a fuel gas container 3 is ejected to a fuel gas supply path 4, decompressed with decompression valves, here, a primary decompression valve 5 and a secondary decompression valve 6 and then introduced into an anode intake part 7 of the fuel cell stack 2. The vehicular fuel cell system 1 does not have a high pressure compressor, unlike the fuel cell system of the water-cooling type, but does use air sucked to a cathode intake path 9 through a filter 8 as the reaction gas and refrigerant and supplies the air to a cathode intake part 11 of the fuel cell stack 2 by a low-pressure blower fan 10. The air supplied to the cathode intake part 11 of the fuel cell stack 2 functions not only as the reaction gas with the fuel gas for power generation reaction in the cells that are stacked in the fuel cell stack 2 but also as refrigerant for taking waste heat of the fuel cell stack 2 to cool the fuel cell stack 2. The air after the reaction with the fuel gas and the air after cooling the fuel cell stack 2 are exhausted from a cathode exhaust part 12 of the fuel cell stack 2 to a cathode exhaust path 13 and are thus discharged to the outside air. Anode exhaust which is exhausted from an anode exhaust part 14 of the fuel cell stack 2 to an anode exhaust path 15 joins the cathode exhaust on the way of the cathode exhaust path 13 through a purge valve 16. When purging the fuel gas included in the anode exhaust, the fuel gas to be exhausted is diluted to a lower flammable limit density or lower by the cathode exhaust and is then discharged to the outside air.

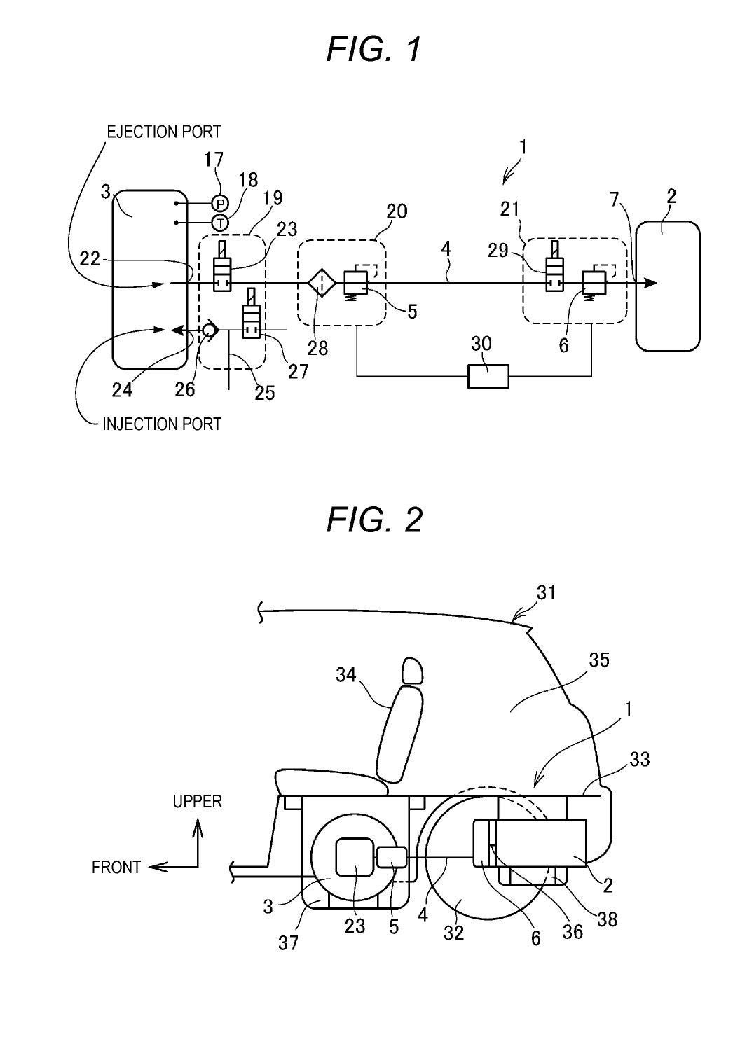

As shown in FIG. 1, the vehicular fuel cell system 1 supplies the fuel gas from the fuel gas container 3 to the fuel cell stack 2 through the fuel gas supply path 4. The fuel gas container 3 has a pressure sensor 17 and a temperature sensor 18. A container main valve unit 19, a primary decompression valve unit 20 and a secondary decompression valve unit 21 are disposed in this order from the fuel gas container 3 towards the fuel cell stack 2 on the fuel gas supply path 4. The container main valve unit 19 is fixed to the fuel gas container 3 and is provided with a first shutoff valve 23 for shutting off the fuel gas that is ejected from an ejection port 22 of the fuel gas container 3 to the fuel gas supply path 4. The container main valve unit 19 is provided with a fuel gas injection path 25 for injecting the fuel gas through a injection port 24 of the fuel gas container 3. The fuel gas injection path 25 is provided thereon with a check valve 26 and a container safety valve 27. The primary decompression valve unit 20 is fixed to the fuel gas container 3 adjacent to the container main valve unit 19 and is provided with a filter 28 for filtering out the fuel gas ejected to the fuel gas supply path 4 and the primary decompression valve 5. The secondary decompression valve unit 21 is fixed to the fuel cell stack 2 and is provided with a second shutoff valve 29 for shutting off the fuel gas ejected to the fuel gas supply path 4 and the secondary decompression valve 6. The first shutoff valve 23 is disposed on the fuel gas supply path 4 at an upstream side of the primary decompression valve 5. The second shutoff valve 29 is attached at a fuel gas entrance-side of the secondary decompression valve 6 and at an immediately upstream side of the secondary decompression valve 6. In the vehicular fuel cell system 1, the primary decompression valve 5 and the secondary decompression valve 6 are disposed on the fuel gas supply path 4 in this order from the upstream side. In other words, the secondary decompression valve 6 is disposed on the fuel gas supply path 4 at a downstream side of the primary decompression valve 5. A control device 30 is configured to close the second shutoff valve 29 prior to the first shutoff valve 23 at the time of a shutdown operation of the fuel cell stack 2. The secondary decompression valve 6 is fixed to the fuel cell stack 2. The secondary decompression valve 6 is configured to decompress the fuel gas to a pressure close to the atmospheric pressure and supply the fuel gas to the anode intake part 7 of the fuel cell stack 2. The fuel cell stack 2 uses the air having the pressure close to the atmospheric pressure as both the reaction gas and refrigerant.

As shown in FIG. 2, the vehicular fuel cell system 1 is mounted on a vehicle 31. In the vehicle 31, a rear seat 34 is disposed on a rear floor panel 33 between rear wheels 32 and a trunk 35 is formed on the rear floor panel 33 behind the rear seat 34. In the vehicular fuel cell system 1, the fuel cell stack 2 is mounted below the rear floor panel 33 on which the trunk 35 is formed and the fuel gas container 3 is mounted below the rear floor panel 33 on which the rear seat 34 is disposed. The fuel gas in the fuel gas container 3 passing through the first shutoff valve 23 of the container main valve unit 19 is decompressed by the primary decompression valve 5 of the primary decompression valve unit 20 and then ejected to the fuel gas supply path 4. The fuel gas passing through the fuel gas supply path 4 is decompressed to a pressure substantially equal to the atmospheric pressure by the secondary decompression valve 6 of the secondary decompression valve unit 21 which is integrated with the fuel cell stack 2 and then supplied to the anode intake part 7 of the fuel cell stack 2 through a connection pipe 36. At the periphery of the fuel gas container 3, the fuel gas container 3, the first shutoff valve 23 and the primary decompression valve 5 are integrated by one basket-shaped frame 37 and are attached to the vehicle 31. At the periphery of the fuel cell stack 2, the fuel cell stack 2 and the secondary decompression valve 6 are integrated by one basket-shaped frame 38 and are attached to the vehicle 31.

Regarding the fuel gas that is supplied to the fuel cell stack 2, the pressure of the fuel gas is very low and is substantially the same as the atmospheric pressure in the vehicular fuel cell system 1 of the air-cooling type. Thus, if the fuel cell stack 2 and the fuel gas container 3 are spaced apart from each other, the fuel gas supply path 4 connecting the fuel cell stack 2 and the fuel gas container 3 increases in length, so that pressure loss occurs. As a result, a problem occurs in that the fuel gas is not supplied to the fuel cell stack 2 with a required pressure. In the vehicular fuel cell system 1 of the air-cooling type, the fuel gas is typically decompressed in two steps through the primary decompression valve 5 and the secondary decompression valve 6. In order to solve the problem that the pressure of the fuel gas is reduced due to the pressure loss, the vehicular fuel cell system 1 according to the embodiment of the present invention integrates the secondary decompression valve 6 with the fuel cell stack 2 and mounts the secondary decompression valve 6 on the vehicle 31. Although the secondary decompression valve 6 can be mounted immediately behind the primary decompression valve 5 and immediately in front of the fuel cell stack 2, the secondary decompression valve 6 is integrated with the fuel cell stack 2 and is then mounted on the vehicle as shown in FIG. 2 in this embodiment, considering the pressure loss. According to the vehicular fuel cell system 1, since the secondary decompression valve 6 is fixed to the fuel cell stack 2, it is possible to reduce a passage length of the fuel gas supply path 4 from the secondary decompression valve 6 to the fuel cell stack 2. Thus, it is possible to prevent the pressure of the fuel gas to be supplied to the fuel cell stack 2 from being reduced due to the pressure loss that occurs at the downstream side of the secondary decompression valve 6 on the fuel gas supply path 4. Therefore, the vehicular fuel cell system 1 can supply the fuel gas to the fuel cell stack 2 with an appropriate pressure during the operation of the fuel cell stack 2. According to the vehicular fuel cell system 1, since it is possible to attach and detach the secondary decompression valve 6 to and from the vehicle in a state where the secondary decompression valve 6 is mounted on the fuel cell stack 2 in advance, the mounting capability of the secondary decompression valve 6 and the fuel gas supply path is improved and the maintenance capability is also improved.

In the vehicular fuel cell system 1, one fuel gas supply path 4 connects the fuel gas container 3 and the fuel gas stack 2 therebetween. When the vehicular fuel cell system 1 is shut down by a certain control, such as the stop of the vehicle 31, the first shutoff valve 23 of the fuel gas container 3 is closed. However, immediately after the first shutoff valve 23 is closed, the high-pressure fuel gas remains on the fuel gas supply path 4, so that the fuel gas is supplied to the fuel cell stack 2 until the input pressure to the secondary decompression valve 6 is reduced. Meanwhile, in the fuel cell system of the air-cooling type, since the air is always supplied, the fuel cell stack 2 is held at an open circuit voltage (a potential difference at a state where load is not applied to the outside). In the vehicular fuel cell system 1, when the startup and the shutdown are repeatedly performed, the state of the open circuit voltage continues long, so that the lifespan shortening of the fuel cell stack 2 is accelerated. Also, the high voltage is held, so that the safety is deteriorated. In addition, the consumption of the fuel gas remaining in the fuel gas supply path 4 is not originally necessary from a standpoint of the control. Therefore, the unnecessary consumption of the fuel gas is increased, so that a running distance of the vehicle 31 is shortened. Considering the above, it is preferable that a distance between the second shutoff valve 29 and the secondary decompression valve 6 is short. Thus, according to the vehicular fuel cell system 1, the second shutoff valve 29 is attached to the fuel gas entrance-side of the secondary decompression valve 6. Also, according to the vehicular fuel cell system 1, the first shutoff valve 23 is disposed at the upstream side of the primary decompression valve 5 on the fuel gas supply path 4 and the second shutoff valve 29 is closed prior to the first shutoff valve 23 at the time of the shutdown operation of the fuel cell stack 2. Thereby, according to the vehicular fuel cell system 1, it is possible to reduce a volume of a space in the fuel gas supply path at a downstream side of the second shutoff valve 29 and to shorten the piping between the secondary decompression valve 6 and the second shutoff valve 29, thereby reducing the number of parts. Also, since the second shutoff valve 29 is closed prior to the first shutoff valve 23 at the time of the shutdown operation of the fuel cell stack 2, it is possible to reduce an amount of the fuel gas to be supplied to the fuel cell stack 2 after closing the second shutoff valve 29, thereby preventing the power generation from continuing long. Therefore, it is possible to avoid the unnecessary consumption of the fuel gas, which is caused as the extra fuel gas is supplied to the fuel cell stack 2 after the shutdown operation of the fuel cell stack 2. Also, since it is possible to prevent the fuel cell stack 2 from being held at the high voltage for a long time, which is caused as the power generation continues long, the safety is improved. After the operation of the fuel cell stack 2 stops, the fuel gas is enclosed in a part of the fuel gas supply path 4, which is interposed between the primary decompression valve 5 and the second shutoff valve 29, so that an internal pressure of the corresponding part is kept at a predetermined pressure. Therefore, when starting the fuel cell stack 2 next time, it is possible to prevent the internal pressure of the part interposed between the primary decompression valve 5 and the second shutoff valve 29 on the fuel gas supply path 4 from being extremely changed (the pressurization and decompression are repeated). Hence, it is possible to improve the durability of the piping or seal parts arranged at the part interposed between the primary decompression valve 5 and the second shutoff valve 29.

Also, the vehicular fuel cell system 1 has a structure in which the secondary decompression valve 6 decompresses the fuel gas to a pressure close to the atmospheric pressure. In this case, the pressure of the fuel gas that is supplied to the fuel cell stack 2 is highly influenced by the pressure loss occurring in the fuel gas supply path 4 at the downstream side of the secondary decompression valve 6. Therefore, as shown in FIG. 2, when the secondary decompression valve 6 is attached in the vicinity of the fuel gas entrance-side of the fuel cell stack 2, the advantageous effect of the embodiment of the present invention that it is possible to prevent the pressure reduction of the fuel gas to be supplied to the fuel cell stack 2, which is caused due to the pressure loss occurring at the downstream side of the secondary decompression valve 6, becomes more conspicuous. Also, the vehicular fuel cell system 1 is a fuel cell stack of the air-cooling type in which the fuel cell stack 2 uses the air having a pressure close to the atmospheric pressure as the reaction gas and refrigerant. Therefore, when the structure of the embodiment the present invention is applied to the fuel cell stack of the air-cooling type in which the fuel cell stack 2 uses the air having the pressure close to the atmospheric pressure as the reaction gas and refrigerant, the advantageous effect of the embodiment of the present invention becomes more remarkable.

As shown in FIG. 2, the vehicular fuel cell system 1 has the structure in which the fuel gas container 3, the first shutoff valve 23 and the primary decompression valve 5 are integrated by one basket-shaped frame 37 at the periphery of the fuel gas container 3 and the fuel gas stack 2 and the secondary decompression valve 6 are integrated by one basket-shaped frame 38 at the periphery of the fuel gas stack 2. The integrated parts are prepared in advance, so that the vehicular fuel cell system 1 can be mounted to the vehicle 31 by a simple process of mounting the two basket-shaped frames 37, 38 on the vehicle 31 and then connecting the same with the fuel gas supply path 4. Therefore, the mounting capability to the vehicle 31 and the maintenance capability are improved. In the above embodiment, the present invention is applied to the vehicular fuel cell system 1 in which the fuel gas is decompressed in two steps through the primary decompression valve 5 and the secondary decompression valve 6. However, the invention is not limited to the two-step decompression and can be also applied to the one-step decompression.

The invention can reduce the pressure loss of the fuel gas that is supplied to the fuel cell stack mounted on the vehicle and improve the mounting capability and maintenance capability and can be applied to the fuel cell system of the water-cooling type as well as the fuel cell system of the air-cooling type

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A vehicular fuel cell system comprising:
a fuel gas container;
a fuel cell stack;
a fuel gas supply path configured to supply fuel gas from the fuel gas container to the fuel cell stack;
a primary decompression valve disposed on the fuel gas supply path; and
a secondary decompression valve disposed on the fuel gas supply path at a downstream side of the primary decompression valve,
wherein the secondary decompression valve is fixed to the fuel cell stack.

2. The vehicular fuel cell system according to claim 1,
wherein a first shutoff valve is disposed on the fuel gas supply path at an upstream side of the primary decompression valve and a second shutoff valve is arranged at a fuel gas entrance-side of the secondary decompression valve, and
wherein the second shutoff valve is closed prior to the first shutoff valve at the time of a shutdown operation of the fuel cell stack.

3. The vehicular fuel cell system according to claim 1, wherein the secondary decompression valve is configured to decompress the fuel gas to a pressure close to an atmospheric pressure.

4. The vehicular fuel cell system according to claim 3, wherein the fuel cell stack is of an air-cooling type in which air having a pressure close to an atmospheric pressure is used as both a reaction gas and a refrigerant.
